(19) United States
(12) Patent Application Publication
(10) Pub. No.: US 2022/0369612 A1
(43) Pub. Date: Nov. 24, 2022

(54) COLLAPSIBLE AND RAPIDLY DEPLOYABLE LANDING NETS

(71) Applicant: Joseph Wrobel, Hillsboro, OR (US)

(72) Inventor: Joseph Wrobel, Hillsboro, OR (US)

(21) Appl. No.: 17/368,487

(22) Filed: Jul. 6, 2021

Related U.S. Application Data
(60) Provisional application No. 63/191,276, filed on May 20, 2021.

(51) Int. Cl. A01K 77/00; A01K 75/00

(52) U.S. Cl. CPC A01K 77/00; A01K 75/00

(57) ABSTRACT

Landing nets including a handle, a pivot mechanism, a frame, and a net. The pivot mechanism is mounted to the handle and configured to pivot between a stowed configuration and a deployed configuration. The frame is mounted to the pivot mechanism. The frame overlies the handle in the stowed configuration and is disposed distal the handle in the deployed configuration. The net is supported by the frame. In some examples, the landing net includes a container configured to contain at least a portion of the frame when the frame is in the collapsed configuration.

### CROSS REFERENCE TO RELATED APPLICATIONS

This application claims priority to copending U.S. Application, Ser. No. 63/191,276, filed on May 20, 2021, which is hereby incorporated by reference for all purposes.

### BACKGROUND

The present disclosure relates generally to fishing nets. In particular, collapsible and rapidly deployable landing nets are described.

Fishing nets are a commonly used tool when catching fish. Fishing nets come in a variety of types. One type is known as a landing net, which is a handheld net used to retrieve a fish caught by a fishing line out of the water. A landing net typically includes a handle, a hoop frame, and a net.

When fishing for large fish, such as salmon and steelhead, which can grow up to 40 pounds, a large landing net is required. However, large landing nets are bulky and heavy and are cumbersome to carry while fishing.

Given the cumbersome nature of existing large landing nets, a common practice is to set the landing net on the ground so that the fisherman does not have to hold it. Setting the landing net down, however, forces the fisherman to remain stationary near the landing net. Remaining stationary limits a fisherman's ability to catch fish because moving along a riverbank is often necessary to catch fish effectively.

Some landing nets existing today seek to address the mobility and cumbersome issues by being collapsible. However, existing collapsible landing nets suffer from a variety of drawbacks. For example, conventional collapsible landing nets are size limited and not large enough to catch large fish. Another drawback of conventional collapsible landing nets is that they are slow and inconvenient to deploy and collapse.

Thus, there exists a need for landing nets that improve upon and advance the design of known landing nets. Examples of new and useful landing nets relevant to the needs existing in the field are discussed below.

### SUMMARY

The present disclosure is directed to landing nets including a handle, a pivot mechanism, a frame, and a net. The pivot mechanism is mounted to the handle and configured to pivot between a stowed configuration and a deployed configuration. The frame is mounted to the pivot mechanism. The frame overlies the handle in the stowed configuration and is disposed distal the handle in the deployed configuration. The net is supported by the frame. In some examples, the landing net includes a container configured to contain at least a portion of the frame when the frame is in the collapsed configuration.

### BRIEF DESCRIPTION OF THE DRAWINGS

FIG. 1 is a perspective view of a landing net in a deployed configuration.

FIG. 2 is a perspective view of the landing net shown in FIG. 1 in a stowed configuration with a frame and net contained inside a container.

FIG. 3 is a front view of the landing net shown in FIG. 1 in the stowed configuration without a container to depict the frame in a collapsed configuration.

FIG. 4 is a close-up front view of a pivot mechanism of the landing net shown in FIG. 1 depicting a handle and the frame attached to the pivot mechanism.

FIG. 5 is a perspective view of the pivot mechanism shown in FIG. 4 separate from the handle and the frame.

FIG. 6 is a front view of the landing net shown in FIG. 1 in the deployed configuration with the handle telescopically extended.

### DETAILED DESCRIPTION

The disclosed landing nets will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of landing net examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Collapsible and Rapidly Deployable Landing Nets

With reference to the figures, collapsible and rapidly deployable landing nets will now be described. The landing nets discussed herein function to retrieve caught fish from the water. The landing nets further function to selectively collapse and deploy for user convenience.

The reader will appreciate from the figures and description below that the presently disclosed landing nets address many of the shortcomings of conventional landing nets. For example, the landing nets discussed below are large enough to catch large fish without the bulk and excessive weight of conventional large landing nets. Further, the landing nets disclosed herein are compact and easy to carry while fishing.

The landing nets discussed in this application being convenient to carry removes the need to set them on the ground. Thus, the landing nets disclosed herein enable fishermen to be more mobile and to more effectively catch fish by moving along a riverbank as needed.

Unlike conventional collapsible landing nets, the landing nets described below are large enough to catch large fish. Significantly improving over conventional collapsible landing nets is the presently disclosed landing nets' ability to deploy and collapse quickly and conveniently. In most instances, the landing nets are configured to be deployed with one hand in less than one second.

### Landing Net Embodiment One

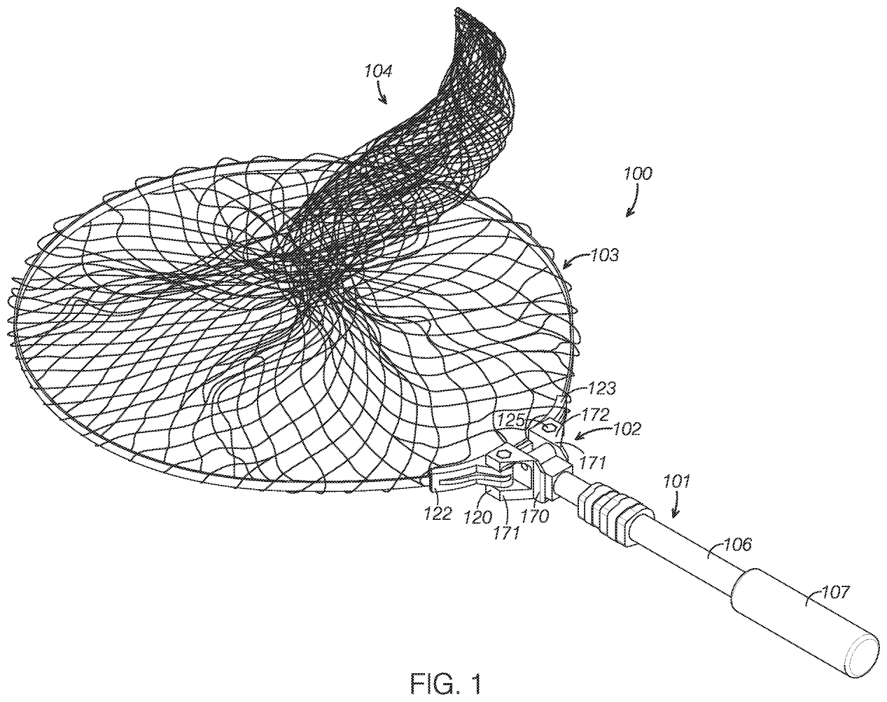

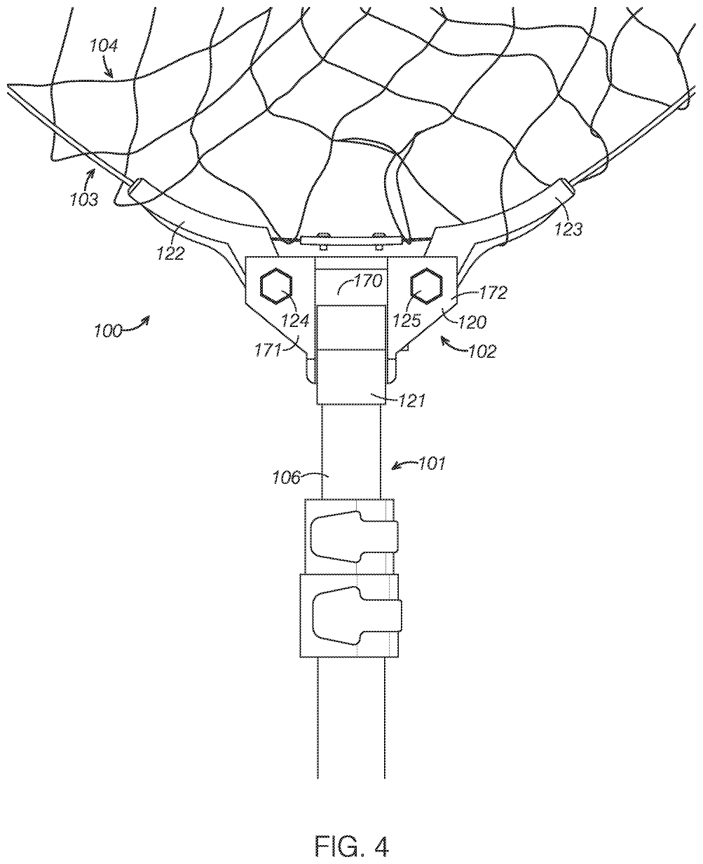

With reference to FIGS. 1-6, a first example of a landing net, landing net 100, will now be described. Landing net 100 includes a handle 101, a pivot mechanism 102, a frame 103, a net 104, and a container 105. In some examples, the landing net does not include one or more features included in landing net 100, such as container 105. In other examples, the landing net includes additional or alternative features than depicted in the figures.

Handle

As shown in FIGS. 1-4 and 6, handle 101 functions to support pivot mechanism 102 and to enable a user to manipulate landing net 100. In the example shown in FIGS. 1-6, handle 101 is mounted to a pole pivot 121 of pivot mechanism 102. As can be seen in FIGS. 1-4 and 6, handle 101 includes a pole system 106 and a grip 107.

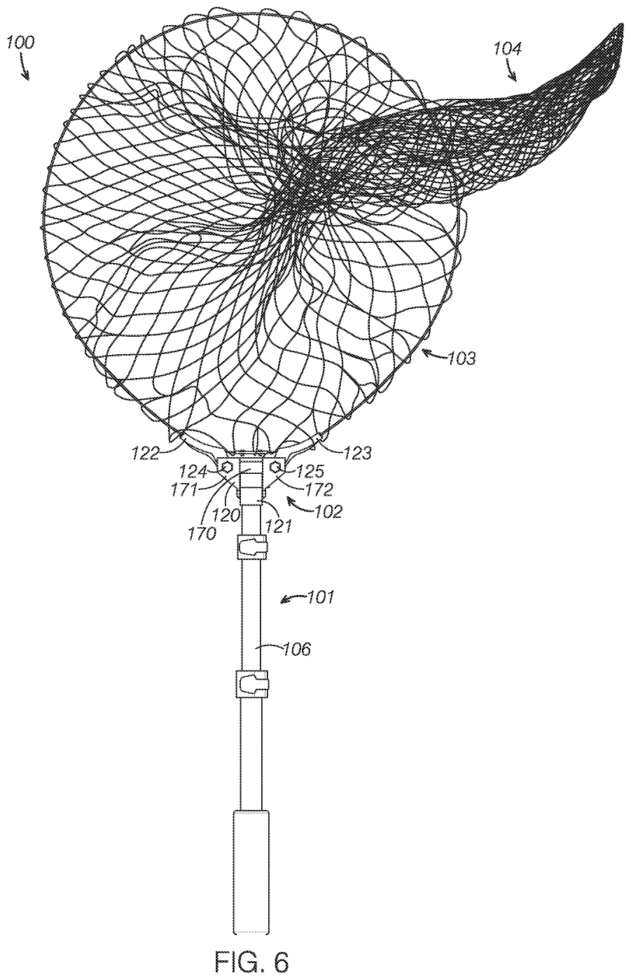

Pole system 106 is configured to selectively telescope to longer and shorter lengths. FIG. 6 depicts pole system 106 in an extended length configuration and FIGS. 1-4 depict pole system 106 in a retracted length configuration. In some examples, the handle includes a fixed length pole instead of a telescoping pole system.

Grip 107 is an optional feature that facilitates comfortably manipulating handle 101. The reader can see in FIGS. 1-3, and 6 that grip 107 is cushioned and attached to an end of pole system 106 distal pivot mechanism 102.

Pivot Mechanism

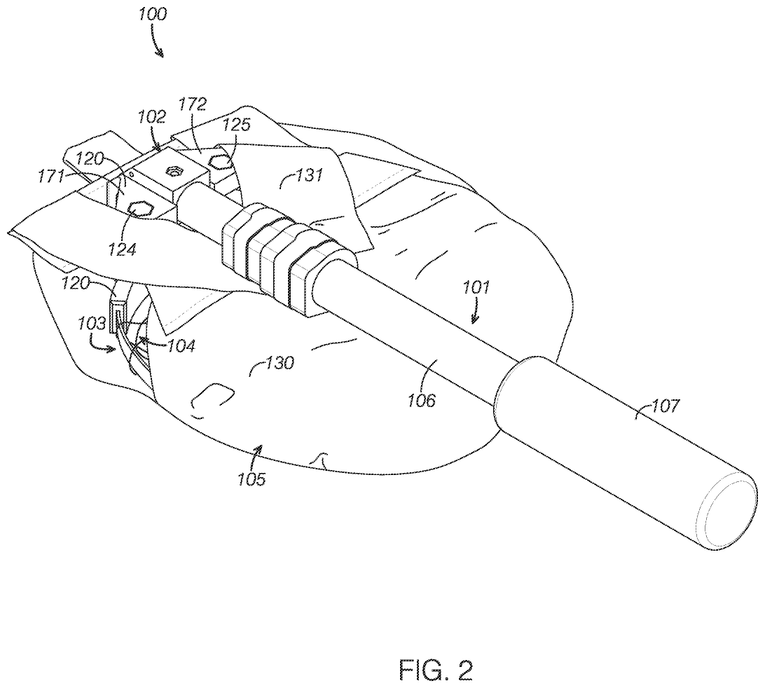

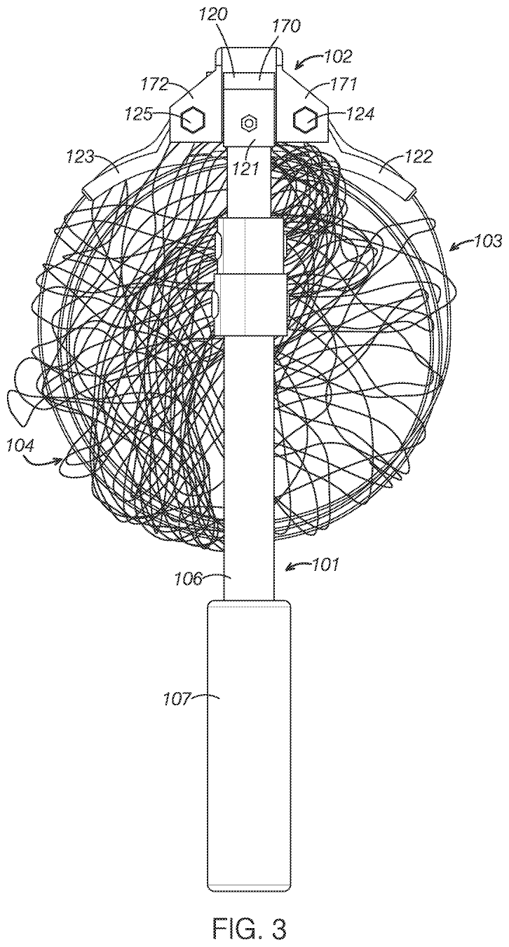

Pivot mechanism 102 serves to selectively alter the configuration of landing net 100 between a stowed configuration shown in FIGS. 2 and 3 and a deployed configuration shown in FIGS. 1, 4, and 6. In the stowed configuration, landing net 100 is compact and convenient to store on one's person. As shown in FIG. 2, in the stowed configuration pivot mechanism 102, frame 103, and net 104 may be contained within container 105, or, as shown in FIG. 3, may not be contained within container 105. In the deployed configuration, landing net 100 is operable to retrieve fish from the water.

Pivot mechanism 102 and landing net 100 as a whole are configured to enable a user to switch landing net 100 from the stowed configuration to the deployed configuration rapidly and easily. In many examples, a user may switch landing net 100 from the stowed configuration to the deployed configuration within one second. Conveniently, the user may transition landing net 100 from the stowed configuration to the deployed configuration with just one hand.

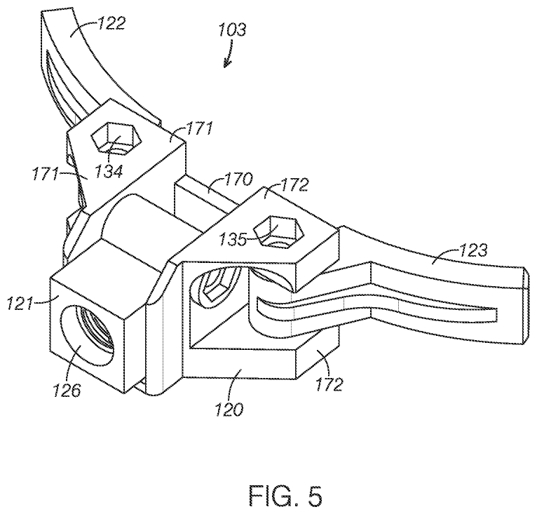

As shown in FIGS. 1 and 3-6, pivot mechanism 102 includes a base 120, a pole pivot 121, a first fork 122, and a second fork 123. With reference to FIG. 5, the reader can see that base 120 includes a torso 170, a first shoulder 171, and a second shoulder 172. First shoulder 171 is laterally adjacent to the torso 170. Second shoulder 172 is laterally adjacent to torso 170 on an opposite side of torso 170 from first shoulder 171.

As depicted in FIGS. 1 and 3-6, base 120 along with fasteners function to pivotally support pole pivot 121 and the forks. A first shaft (not pictured) couples pole pivot 121 to torso 170 of base 120. The first shaft defines a bearing surface on which pole pivot 121 rests and pivots.

Pole pivot 121 is configured to pivot 180 degrees between furled and unfurled configurations. In the furled configuration shown in FIGS. 2 and 3, landing net 100 is in the stowed configuration. In the unfurled configuration shown in FIGS. 1, 4, 5, and 6, landing net 100 is in the deployed configuration. Pole pivot 121 is configured to lock into the unfurled configuration to maintain that configuration until manually moved to the furled configuration.

A second shaft 124 and a third shaft 125 shown in FIGS. 1-4, and 6 couple the forks to first shoulder 171 and second shoulder 172 of base 120 and define bearing surfaces on which the forks rest and pivot. As shown in FIG. 5, base 120 defines hexagon shaped recesses 134 and 135 complementarily configured with hexagon shaped heads of the fasteners to restrict the fasteners from rotating relative to base 120.

With reference to FIG. 5, the reader can see that pole pivot 121 defines a recess 126 complementarily configured with handle 101. As can be seen in FIGS. 1-4 and 6, pole system 106 inserts into recess 126 of pole pivot 121 to couple with pole pivot 121.

First fork 122 and second fork 123 define channels complementarily configured with frame 103. The reader can see in FIGS. 1-4 and 6 that frame 103 inserts into the channels defined by the forks to couple frame 103 to the forks.

The forks may be larger or smaller to increase or decrease, respectively, the size of the landing net. The reader should understand that the different size forks are interchangeable in the pivot mechanism depending on the desired size of the landing net.

In the example shown in FIGS. 1-6, pivot mechanism 102 is composed of plastic components except for the shafts composed of metal. However, the pivot mechanism may be composed of any currently known or later developed material suitable for pivot mechanisms, including metals, wood, ceramics, polymers, and composites.

Frame

Frame 103 functions to support net 104. As shown in FIGS. 1, 4, and 6, frame 103 supports net 104 in a configuration defining a net opening through which fish enter and exit net 104. In the example shown in FIGS. 1, 4, and 6, frame 103 defines a substantially circular or teardrop shaped opening, but may define openings with other shapes, such as oval, triangular, square, rectangular, other regular polygons, or irregular shapes.

As shown in FIGS. 1-4 and 6, frame 103 couples to pivot mechanism 102. As explained above, frame 103 couples to pivot mechanism 102 by inserting into channels defined in forks 122 and 123.

The size of the frame may be varied to suit a given application. In FIGS. 1-4 and 6, frame 103 is sized to define a 24-inch diameter opening when landing net 100 is in the deployed configuration and to define a 9-inch diameter opening when landing net 100 is in the stowed configuration. In other examples, the frame is sized to define a 32-inch opening when the landing net is in the deployed configuration and to define a 12-inch diameter opening when the landing net is in the stowed configuration. Frames defining larger and smaller openings are contemplated.

In a configuration similar to collapsible sun shades for car windshields, frame 103 is flexible and configured to fold upon itself to a smaller size when landing net 100 is in the stowed configuration. However, the metal strip of frame 103 is significantly stronger than corresponding metal strips used in collapsible sun shades. In the example shown in FIGS. 1-6, frame 103 is configured to fold upon itself to transition from its 24-inch diameter opening size in the deployed configuration to a 9-inch diameter opening size in the stowed configuration.

Frame 103 is biased toward the deployed configuration. The bias towards the deployed configuration causes frame 103 to automatically and rapidly unfold to the 24-inch diameter opening size of the deployed configuration when released from container 105 or when external forces holding it in the folded, stowed configuration are removed.

Net

Net 104 serves to contain and support fish when removing them from the water. Net 104 is a flexible mesh of elongate tension bearing members. As shown in FIGS. 1, 3, and 6, frame 103 passes through mesh openings in net 104 to couple frame 103 and net 104 together.

The net may be any currently known or later developed type of net. The net may be formed from any suitable material that is currently known or later developed. The net may be any size suitable for a given type of fish or fishing technique.

Container

As shown in FIG. 2, container 105 functions to contain frame 103 and net 104 when landing net 100 is in the stowed configuration. Container 105 is configured to restrict the bias of frame 103 towards its expanded configuration to keep frame 103 in its compact configuration when frame 103 is disposed in container 105. To transition landing net 100 from the stowed configuration to the deployed configuration, a user simply removes frame 103 from container 105. The bias of frame 103 expands frame 103 to its expanded size and pivots pole pivot 121 by 180 degrees from its furled configuration to its unfurled configuration.

In the present example, as shown in FIG. 2, container 105 is a bag with a pouch 130 and a flap 131. In other examples, the container is a strap that extends around a portion of the frame and the net rather than a bag with a pouch that covers a majority of the frame and the net in the stowed configuration.

Flap 131 functions to selectively restrict frame 103 and net 104 from exiting pouch 130 until a user exerts a threshold extraction force on flap 131, such as by pulling on handle 101 to press frame 103 and/or pivot mechanism 102 against flap 131. The threshold extraction force is selected to be easily exceeded when intentionally pulling on frame 103, but strong enough to withstand routine jostling and minor snags not intended to withdraw frame 103 from container 105.

Flap 131 is integrally coupled to pouch 130 on a first end of flap 131 and selectively couples to pouch 130 on a second end of flap 131 across an opening of pouch 130. In the present example, flap 131 selectively couples to pouch 130 via a hook-and-loop fastener. In other examples, the flap selectively couples to the pouch by means other than hook-and-loop fasteners, such as by magnetic fasteners, detents, or other mechanical fasteners.

The reader can see in FIG. 2 that handle 101 resides outside of container 105 in the present example, but may be fully or partially contained within the container in some examples and/or configurations. Pulling on handle 101 functions to overcome the threshold extraction force holding flap 131 to pouch 130 to open pouch 130 and to extract frame 103 and net 104 from container 105. Extracting frame 103 from pouch 130 rapidly converts landing net 100 from the stowed configuration to the deployed configuration.

The container may be any currently known or later developed type of container. The container may be formed from any suitable material that is currently known or later developed, such as leather, fabric, polymers, wood, or metal. The container may be any size suitable for a given frame.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A landing net, comprising:
a handle;
a pivot mechanism mounted to the handle and configured to pivot between a stowed configuration and a deployed configuration;
a frame mounted to the pivot mechanism, the frame overlying the handle in the stowed configuration and being disposed distal the handle in the deployed configuration; and
a net supported by the frame.

2. The landing net of claim 1, wherein the frame is configured to move between a collapsed configuration and an expanded configuration.

3. The landing net of claim 2, wherein:
the frame is in the collapsed configuration when the pivot mechanism is in the stowed configuration; and
the frame is in the expanded configuration when the pivot mechanism is in the deployed configuration.

4. The landing net of claim 2, wherein the frame is flexible and configured to fold upon itself to move from the expanded configuration to the collapsed configuration.

5. The landing net of claim 2, wherein the frame is biased towards the expanded configuration.

6. The landing net of claim 5, further comprising a container configured to contain at least a portion of the frame when the frame is in the collapsed configuration.

7. The landing net of claim 6, wherein selectively removing the frame from the container causes the frame to move from the collapsed configuration to the expanded configuration.

8. The landing net of claim 7, wherein the container includes:
a pouch configured to receive at least a portion of the frame when the frame is in the collapsed configuration; and
a flap attached to the pouch and selectively restricting the frame from exiting the pouch.

9. The landing net of claim 8, wherein the flap includes:
a first end fixedly attached to the pouch; and
a second end removably attached to the pouch.

10. The landing net of claim 9, wherein the second end of the flap is removably attached to the pouch with a threshold coupling force.

11. The landing net of claim 10, wherein:
the second end of the flap decouples from the pouch when the second end of the flap is urged away from the pouch with a force exceeding the threshold coupling force; and
the flap allows the frame to exit the pouch when the second end of the flap decouples from the pouch.

12. The landing net of claim 11, wherein:
the threshold coupling force is selected to resist the bias of the frame towards the expanded configuration; and
the threshold coupling force is selected to be overcome when a user selectively urges the second end of the flap away from the pouch.

13. The landing net of claim 12, wherein the user selectively urges the second end of the flap away from the pouch by pressing the frame against the flap.

14. The landing net of claim 13, wherein the user selectively presses the frame against the flap by pulling on the handle.

15. The landing net of claim 10, wherein the second end of the flap removably couples to the pouch with a hook-and-loop fastener mounted to the second end and to the pouch.

16. The landing net of claim 1, wherein the pivot mechanism includes:
a base;
a pole pivot pivotally mounted to the base;
a first fork pivotally mounted to the base; and
a second fork pivotally mounted to the base.

17. The landing net of claim 16, wherein:
the base includes:
a torso;
a first shoulder laterally adjacent to the torso; and
a second shoulder laterally adjacent to the torso on an opposite side of the torso from the first shoulder;
the pole pivot is pivotally mounted to the torso of the base;
the first fork is pivotally mounted to the first shoulder of the base; and
the second fork is pivotally mounted to the second shoulder of the base.

18. The landing net of claim 17, wherein:
the handle is mounted to the pole pivot; and
the pole pivot is configured to pivot 180 degrees relative to the base.

19. The landing net of claim 17, wherein the frame is configured to mount to the first fork and to the second fork.

20. The landing net of claim 1, wherein the handle is configured to telescope between an extended length and a retracted length.
